(19) United States
(12) Patent Application Publication
(10) Pub. No.: US 2004/0244053 A1
(43) Pub. Date: Dec. 2, 2004

(54) Cable tv network frequency range extension with passive bypass device

(76) Inventor: Harel Golombek, Netanya (IL)

Correspondence Address: SUGHRUE MION, PLLC, 2100 PENNSYLVANIA AVENUE, N.W., SUITE 800, WASHINGTON, DC, 20037, US

(21) Appl. No.: 10/486,692

(22) PCT Filed: Aug. 26, 2002
(86) PCT No.: PCT/US02/26988

Related U.S. Application Data
(60) Provisional application No. 60/314,308, filed on Aug. 24, 2001.

(51) Int. Cl. H04N 7/173

(52) U.S. Cl. 725/127; 725/118

(57) ABSTRACT

A passive component bypasses CATV active components (FIG. 3) in order to enable to extend the frequency capabilities of the transmission network by creating a new path allowed through the CATV network, without replacing the existing amplifiers. The input RP and AC (RF+AC) is filtered and outputted as signals above 750/860 MHz (RP above 750/860 MHz), and the AC is coupled and outputted (Low Power AC).

### CROSS-REFERENCE TO RELATED APPLICATIONS

This application claims the benefit of U.S. Provisional Application No. 60/314,308, filed Aug. 24, 2001, which is incorporated by reference, herein, in its entirety.

### FIELD OF THE INVENTION

This invention relates to communications over a CATV system.

### BACKGROUND OF THE INVENTION

The coaxial cable portion of standard cable TV networks obeys tree and branch topology. The list of physical elements in a two way CATV network includes: coaxial cables, amplifiers, power supplies and signal splitters/combiners (known as taps). Usually, in hybrid fiber coax (HFC) CATV networks that were already upgraded to carry video and data signals up to 860 Mhz or 750 Mhz, the RF passive components, like the cables and taps, could transport (with acceptable loss) higher frequencies, except that the already installed CATV amplifiers limit the transport of up-stream signals to about 5-45 Mhz and the down-stream signals to 750 Mhz or 860 Mhz or 1 Ghz (upon the specific amplifier model).

The amplifiers enforce the bidirectional nature of the CATV system, but restrict the usefulness of the CATV network for carrying traffic other than CATV programming and control signals.

### SUMMARY OF THE INVENTION

A passive component, built into a standard Cable TV (CATV) connector (or adapter) such as the KS or IEC type, enables one to by-pass CATV amplifiers and hence allows the operation of the existing CATV network above the standard 860 MHz or 750 Mhz.

By installing these passive by-pass devices at the inputs and outputs of a standard CATV amplifier, a new path is created. This new path allows transporting signals in higher frequencies within the CATV network, without replacing the existing amplifiers and without interfering with CATV programming and control signals.

In addition to passing the AC and CATV RF signals to and from the CATV amplifier, and creating a new path for RF signals above 860 Mhz or 750 Mhz, the passive by-pass device couples small portion of the AC power from the network. This AC power may be used to feed an active element that might be connected between the input by-pass device and the output by-pass device.

The coaxial cables within the CATV network carry both high power Alternating Current (AC) to feed the amplifiers, and low Radio frequency (RF) power signals for the video, data and telephony applications.

Therefore, the passive by-pass device must continue to carry both the AC and RF to and from the existing CATV amplifiers, with minimal loss, in order not to degrade the services to the customer.

The passive by-pass is a 4 port device: 2 input/output ports for RF+AC, one input/output port for RF signals above 860 Mhz or 750 Mhz, and one output port for low power AC to feed other active elements such as by-pass amplifiers.

The last 2 ports may be reduced to one, by sharing the low power AC and above 860/750 Mhz RF, into a single coaxial port.

In this version the by-pass may become a device with only 3 ports.

The by-pass device may be built into the housing of the well-known and widely used KS or IEC connector (adapter). Therefore, the first 2 RF+AC ports are male and female KS or IEC type.

This allows installing the by-pass in between the existing cable and amplifier.

The other 2 ports (other one port in the 3 port version) may be of any connector kind (F-Type, N-Type, TNC, SMA).

The invention is taught below by way of various specific exemplary embodiments explained in detail, and illustrated in the enclosed drawing figures.

### BRIEF DESCRIPTION OF THE DRAWINGS

The drawing figures depict, in highly simplified schematic form, embodiments reflecting the principles of the invention. Many items and details that will be readily understood by one familiar with this field have been omitted so as to avoid obscuring the invention. In the drawings:

FIG. 1 is a view of a prior art CATV amplifier and its connections.

FIGS. 2(a), 2(b), 2(c), and 2(d) show in detail the steps required to install one passive by pass device in between the coax cable and a port of an amplifier.

FIG. 3 shows in detail the mechanical structure of the passive bypass device.

FIGS. 4(a) and 4(b) show a right angle version of the passive by pass device.

FIG. 5 shows two implementations of the passive by pass device, in which FIG. 5(a) uses a simple RF diplexer and FIG. 5(b) shows an alternative method to implement the by pass device, in which the RF loss is cut to a minimum.

FIG. 6 shows one embodiment for implementing an AC-passing diplexer.

### DETAILED DESCRIPTION

The invention will now be taught using various exemplary embodiments. Although the embodiments are described in detail, it will be appreciated that the invention is not limited to just these embodiments, but has a scope that is significantly broader. The appended claims should be consulted to determine the true scope of the invention.

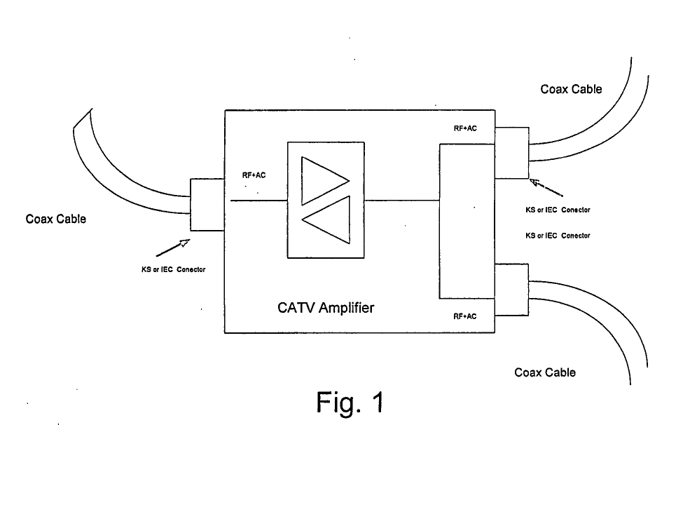

FIG. 1 shows a standard Cable TV amplifier connected to 3 coaxial cables. The left cable may be coming from the CATV head-end side, and the 2 right cables go further down the cable plant towards the home pass. Not all CATV amplifiers really connect to more than 2 ports, even though most amplifiers are provisioned with more than 2 ports.

Cable TV network amplifiers are equipped with a standard KS or IEC type connector.

A male (plug) KS or IEC connector is assembled at the cable end, while the amplifier has a mate KS or IEC female (jack) connector.

The male KS or IEC cable connector may be straight or right-angled.

All ports must withstand the high AC current (up to 20A), to allow the powering of adjacent amplifiers in the network.

The passive by-pass device must be connected to each and every in-use port of the amplifier, in order to make a complete by-pass for the whole network. In the example of FIG. 1, three (3) by-pass devices will be needed.

One may decide to only bypass certain ports of the amplifier. This is acceptable, as long as one understands that the non by-passed ports will not be able to carry the higher frequency signals (above 860/750 Mhz).

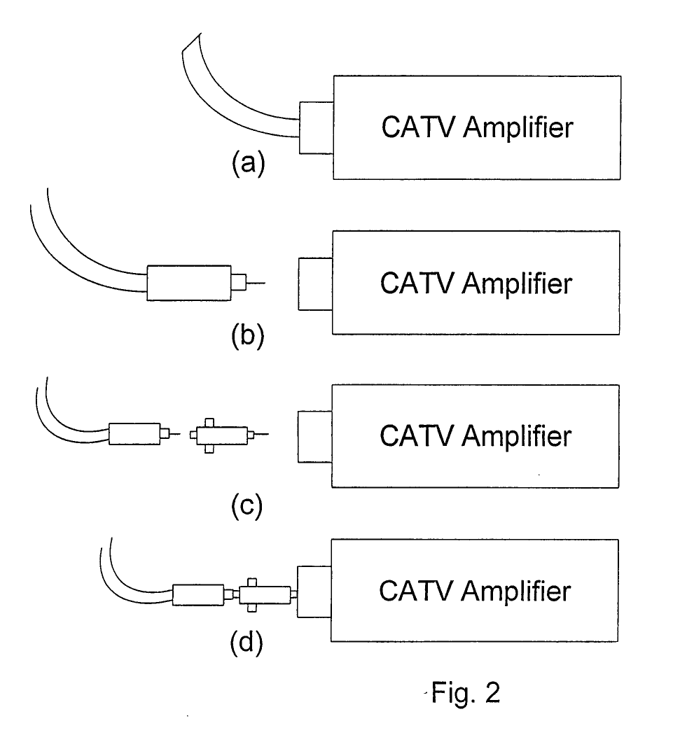

FIG. 2 explains in detail the steps required to install one passive by-pass device in between the coax cable and one port of the amplifier.

FIG. 2a presents the amplifier as it looks before assembling the by-pass device.

The first stage, described by FIG. 2b, is to disconnect the cable from the amplifier by opening the KS connector.

In the next step (FIG. 2c) the passive by-pass device is placed between the cable and the amplifier.

In the last step (FIG. 2d) the by-pass device is being tightly closed to the amplifier, and the cable is tightly closed to the by-pass device.

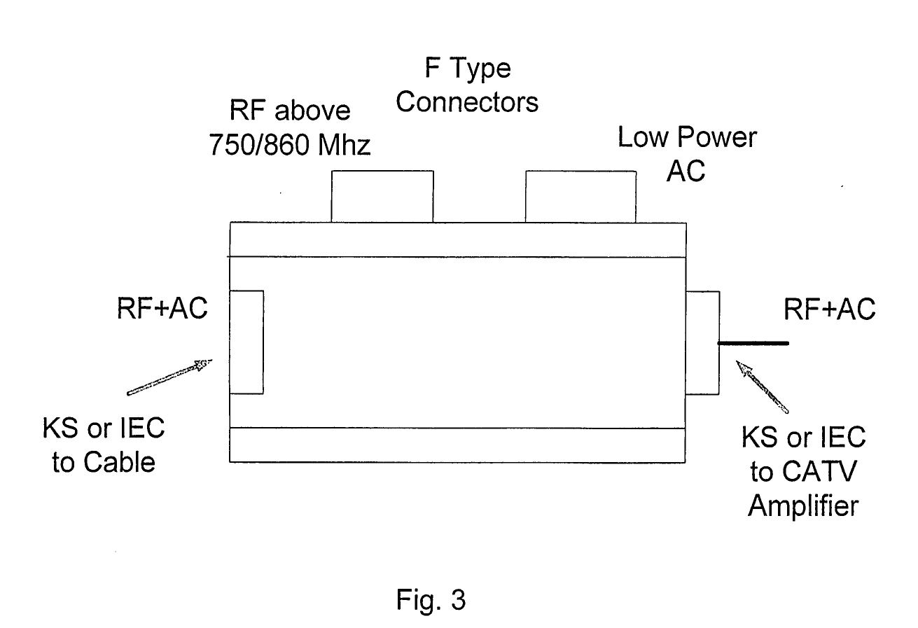

FIG. 3 describes in detail the mechanical structure of the passive by-pass element.

In this figure a 4 port device is presented, but this invention is not limited to only a 4 port device. By combining the functionality of the upper and lower port (high frequencies RF and low power AC) into a single common port, we have a 3 port device.

A 3 port device can save an additional cable to be connected to an active element, and simplify the installation procedure in terms of time and money.

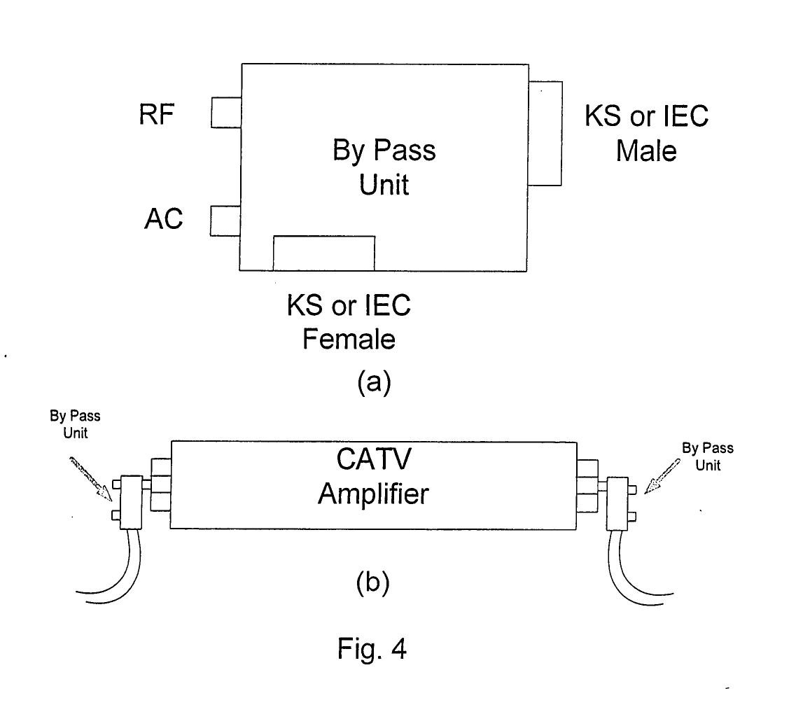

FIG. 4 shows a right angle version of the passive by-pass device. In the right angle version the axis of the 2 KS or IEC port are 90 degrees to each other.

FIG. 4a shows the mechanical layout of the 90 degrees by-pass device.

FIG. 4b shows the benefits of using the 90 degrees by-pass version when bypassing a CATV amplifier (with 2 ports in this example).

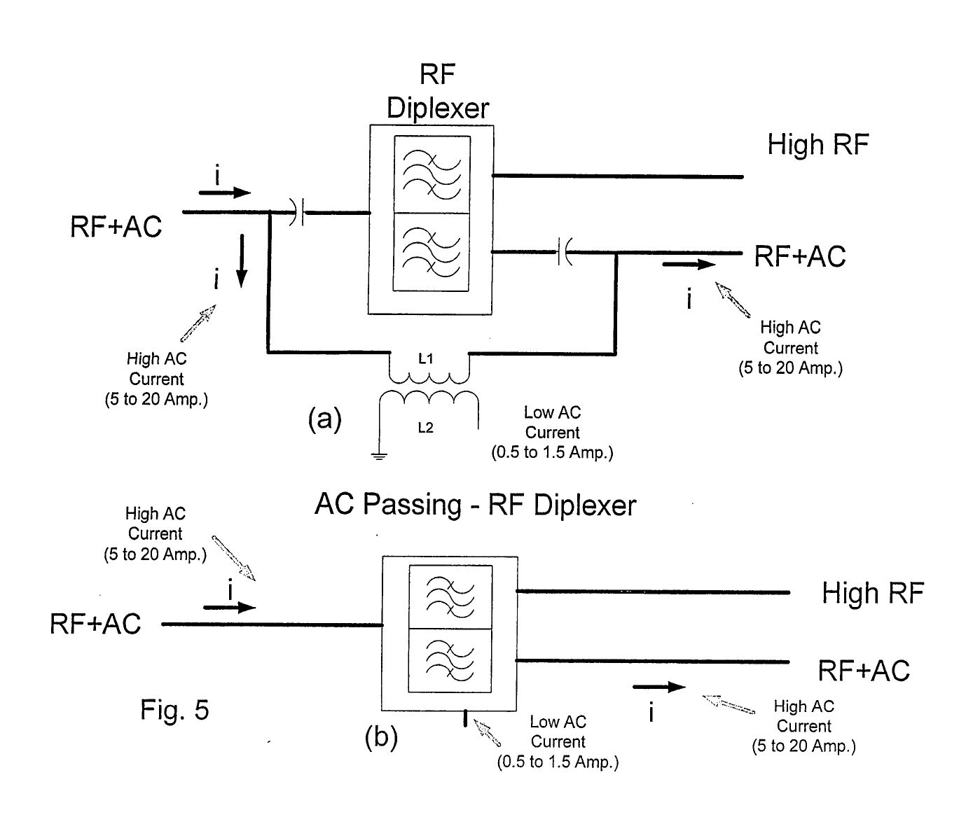

FIG. 5 presents two implementations of the passive by-pass device.

They differ from each other basically by the type of the RF diplexer.

The more straightforward implementation method as shown in FIG. 5a, uses a simple RF diplexer (which is a common and well known component in the RF industry) which is not capable of carrying high AC current. Therefore, additional external components are required to protect the RF diplexer from the high AC current and voltage. This is done by the 2 capacitors (labeled C) which block the 50/60 Hz AC power from reaching the diplexer's ports.

L₁ is an RF chock inductor. It allows the 50/60 Hz AC power to bypass the diplexer and reach the output port. At the same time it blocks the transmission of any RF energy (5 Mhz and up) through it, by presenting very high impedance at these frequencies.

Therefore, the low power RF signals pass inside the diplexer only, and the high AC power signal flows from the device input to its output by the inductor L₁.

L₂ inductor is mounted in close vicinity to L₁, so a small amount of AC power is magnetically coupled by it to the Low Power AC port.

L₁ should be able to carry between 5A-20A of AC current at 60-90 VAC.

Bypass devices that are connected to line extender amplifiers can withstand only up to about 5A through them.

Bypass devices that are connected to trunk amplifiers must be able to transport at least 20A.

The need for additional components such as the 2 capacitors and the RF chock inductor may cause a substantial amount of attenuation to the RF signals while passing within the device. These 2 capacitors and the choke inductor will attenuate both the standard CATV signals (5−860/750 MHz) and the higher frequency (above 860/750 MHz) signals.

Depending upon the specific CATV network architecture, this additional loss may be very difficult to compensate, simply by increasing the CATV amplifier's gain.

FIG. 5b suggests an alternative method to implement the by-pass device, in which the RF loss is cut to minimum.

As can be seen in FIG. 5b, both RF and AC signals enter and leave the RF diplexer.

Actually, there is no internal bypass mechanism for the AC signal as in FIG. 5a.

The elimination of the special components that were used in FIG. 5a to block or pass the AC power makes this method favorable in terms of minimal RF losses.

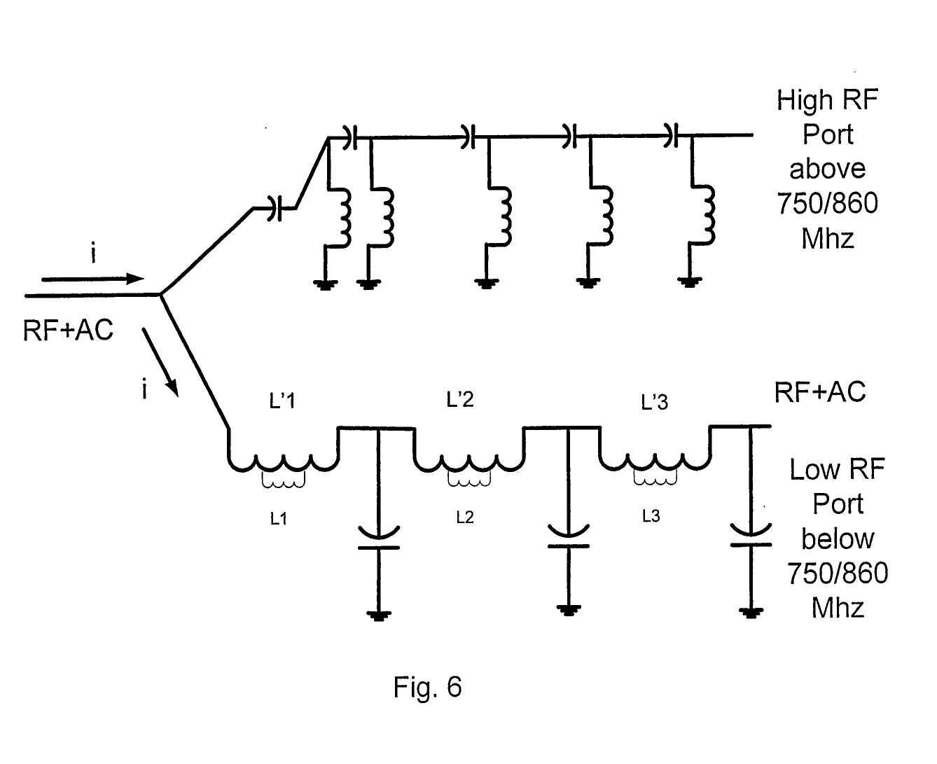

The way to implement this kind of AC-passing diplexer is shown in FIG. 6.

To design an AC-passing device one starts with RF analysis and synthesis CAD tools.

At the end of the CAD design stage, one is left with an electrical layout of lumped components as capacitors and inductors. Each capacitor and inductor is given a specific value, based upon the diplexer specifications (loss, frequencies, rejection, isolation, etc.).

One may choose to design among many High Pass/Low Pass diplexer topologies such as Chebyshev, Elliptic, Bessel and others. Each topology has its unique set of features and capabilities.

FIG. 6 shows an example of one possible topology.

There is one common denominator to all possible types of high/low diplexer topology based on lumped elements—the low pass frequency port from all topologies will have cascaded inductors in series.

They will have cascaded capacitors in series in the high pass frequency port as well, but this is not very important.

Usually, these series inductors (L₁, L₂, L₃) as in the example layout of FIG. 6, will be made out of a small diameter conducting wire. The inductors of the common non AC-passing diplexer, as in FIG. 5a, are made from a small diameter conducting wire.

This is why these inductors can not carry large currents. Due to the small diameter wire, the resistance of the inductor overheats when too high current is present. This overheating can damage the wire completely.

The reason for using the small diameter wire in building the inductors is to have a non-rigid mechanical structure, which can be easily tuned and trimmed during testing.

Usually, these kinds of RF diplexers are tuned in the production line, by varying the inductors' shape and orientation, until the specific value is reached.

This tuning process is done manually by a technician in a trial and error algorithm.

If one implements the inductors by using a high diameter wire, the resulting inductor structure is too stiff, and hence impossible to tune.

FIG. 6 shows a method. by which high diameter wires may be used to build the inductors (that pass the high AC current), and at the same time to allow the manual tuning of the low pass filter section.

This is achieved by implementing each of the series inductors as 2 inductors connected together. The inductors are connected either fully in parallel, or partially in parallel.

One inductor is composed of a high diameter wire and hence cannot be tuned. (The inductors L₁, L₂, L₃ in FIG. 6)

The second inductor is composed of a thin diameter wire and hence its inductance may be varied easily by changing its shape. (The inductors L₁, L₂, L₃ in FIG. 6).

The thick and thin wire inductors, when connected fully or partially in parallel, act as one inductor with an equivalent inductance value. From the RF signals point of view this equivalent value should be tuned to the value as dictated by the synthesis phase.

However, the total AC current will split between the thick and thin inductors, where most of the AC current will flow now through the thick inductor.

Since this inductor is adapted to carry high current ratings, neither of the inductors will experience overheating nor undergo any risk of being damaged.

By Ohm's law, the current that flows into 2 conductors connected fully in parallel will spilt in a manner inversely proportional to the inductors, cross sectional area.

If we build the thick inductor from a 1 mm diameter wire, and the thin inductor from a 0.2 mm diameter wire, and connect them in parallel, the current ratio will be 1 to (0.2)\hat{ }2, which equals to 1:0.04.

Therefore out of a total current of 20A, only 0.8A will flow through the thin inductor.

A 0.2 mm diameter wire can withstand this amount of current easily.

If the thin inductor is connected in parallel only to some of the turn of the thick inductor (partially in parallel), the current within the thin wire inductor is further reduced.

One must make sure the capacitors C₁, C₂, C₃ in the low pass section of FIG. 6, can withstand the AC voltage level of the CATV network (60-90 Volts).

A few of the possible variations have been presented throughout the foregoing discussion. Many more variations to the above-identified embodiments are possible without departing from the scope and spirit of the invention and the appended claims.

There is claimed:

1. A bypass module, comprising:
a common input port for RF and high power AC signals, a first output port for low frequency RF signals and high power AC signals, a second output port for high frequency RF signals, a third output port for low power AC signals, and a diplexer;
wherein the diplexer has an input terminal coupled to the common input port, and an output side comprising:
a low pass frequency terminal coupled to the first output port, and
a high pass frequency terminal coupled to the second output port; and
wherein the low power AC signals of the third output port are derived from the high power AC signals.

2. The bypass module as set forth in claim 1, wherein the input port and the first output port comprise KS, IEC, or F-Type connectors.

3. The bypass module as set forth in claim 1, wherein:
the module further comprises a cover enclosing the diplexer,
the input port and the first output port provide connections at the cover, and
the connections for the input port and the first output port form an angle of substantially 90°.

4. The bypass module as set forth in claim 1, wherein:
a first high AC current blocking and RF passing capacitor is connected in series between the input terminal of the diplexer and the common input port;
a second high AC current blocking and RF passing capacitor is connected in series between the low pass frequency terminal of the diplexer and the first output port.

5. The bypass module as set forth in claim 4, wherein the low power AC signals of the third output port are derived from the high power AC signals by a transformer circuit comprising:
a first inductor coupled between the common input port and the first output port; and
a second inductor operably disposed in relation to the first inductor to provide the low power AC signals.

6. The bypass module as set forth in claim 1, wherein the input terminal of the diplexer is connected directly to the input port, the low pass frequency terminal is connected directly to the first output port, and the low power AC signals of the third output port are provided directly from the diplexer.

7. The bypass module as set forth in claim 1, wherein the diplexer further comprises:
one or more fixed first inductors connected in series with the low pass frequency terminal, each of the first inductors being adapted to operate under the high AC current in a first range;
a tunable second inductor connected at least partially in parallel with one of the first inductors, and adapted to operate under the low AC current in a second range lower than the first range.

8. The bypass module as set forth in claim 7, wherein the first range is 5A-20A.

9. The bypass module as set forth in claim 7, wherein the second range is 5A or less.

10. The bypass module as set forth in claim 7, wherein every one of the first inductors has a corresponding second inductor connected therewith at least partially in parallel.

11. The bypass module as set forth in any one of claims 1 through 10, wherein the second output port outputs RF signals above 750 MHz.

12. The bypass module as set forth in claim 11, wherein the second output port outputs RF signals above 860 MHz.

13. A method of extending an original frequency range of a cable system to include signals in a higher frequency range, comprising:
providing a first bypass module between a first signal cable of the cable system and an existing amplifier of the cable system;
providing a second bypass module between the amplifier of the cable system and a second signal cable of the cable system;
communicating the signals in the higher frequency range via the first bypass module and the second bypass module, and not via the amplifier of the cable system; and
communicating the signals in he original frequency range via the first bypass module, the amplifier of the cable system, and the second bypass module;
wherein:
the signals in the higher frequency range are amplified between the first bypass module and the second bypass module by a bypass amplifier different from the amplifier of the cable system, and
the bypass amplifier is fed with low power AC from one of the first and second bypass modules.

14. The method of range extension as set forth in claim 13, wherein the step of providing the first bypass module comprises providing:
a common input port for RF and high power AC signals, connected to the first signal cable;
a first output port for low frequency RF signals of the lower frequency range and high power AC signals, connected to the amplifier of the cable system;
a second output port for high frequency RF signals of the higher frequency range;
a third output port for providing the low power AC to the bypass amplifier; and
a diplexer;
wherein the diplexer has an input terminal coupled to the common input port, and an output side comprising:
a low pass frequency terminal coupled to the first output port, and
a high pass frequency terminal coupled to the second output port; and
wherein the low power AC signals of the third output port are derived from the high power AC signals.

15. The method of range extension as set forth in claim 14, wherein the input port and the first output port comprise KS, IEC, or F-Type connectors.

16. The method of range extension as set forth in claim 14, wherein:
the module further comprises a cover enclosing the diplexer,
the input port and the first output port provide connections at the cover, and
the connections for the input port and the first output port form an angle of substantially 90°.

17. The method of range extension as set forth in claim 14, wherein:
a first high AC current blocking and RF passing capacitor is connected in series between the input terminal of the diplexer and the common input port;
a second high AC current blocking and RF passing capacitor is connected in series between the low pass frequency s terminal of the diplexer and the first output port.

18. The method of range extension as set forth in claim 17, further comprising providing the low power AC signals of the third output port by derivation from the high power AC signals using a transformer circuit comprising:
a first inductor coupled between the common input port and the first output port; and
a second inductor operably disposed in relation to the first inductor to provide the low power AC signals.

19. The method of range extension as set forth in claim 14, wherein the input terminal of the diplexer is connected directly to input port, the low pass frequency terminal is connected directly to the first output port, and the low power AC signals of the third output port are provided directly from the diplexer.

20. The method of range extension as set forth in claim 14, wherein the diplexer further comprises:
one or more fixed first inductors connected in series with the low pass frequency terminal, each of the first inductors being adapted to operate under the high AC current in a first range;
a tunable second inductor connected at least partially in parallel with one of the first inductors, and adapted to operate under the low AC current in a second range lower than the first range.

21. The method of range extension as set forth in claim 20, wherein the first range is 5A-20A.

22. The method of range extension as set forth in claim 20, wherein the second range is 5A or less.

23. The method of range extension as set forth in claim 20, wherein every one of the first inductors has a corresponding second inductor connected therewith at least partially in parallel.

24. The method of range extension as set forth in any one of claims 14 through 23, wherein the second output port outputs RF signals above 750 MHz.

25. The method of range extension as set forth in claim 24, wherein the second output port outputs RF signals above 860 MHz.
